(19) United States
(12) Patent Application Publication
(10) Pub. No.: US 2003/0099467 A1
(43) Pub. Date: May 29, 2003

(54) IMAGE RECORDING AND REPRODUCING SYSTEM CAPABLE OR CORRECTING AN IMAGE DETERIORATION

(76) Inventors: MANABU INOUE, KOBE-SHI (JP); KEIJI TAMAI, HIGASHIOSAKA-SH (JP); SHIGEAKI IMAI, SAKAI-SHI (JP); KATSUYUKI NANBA, OSAKASAYAMA-SHI (JP)

Correspondence Address: BURNS DOANE SWECKER & MATHIS L L P, POST OFFICE BOX 1404, ALEXANDRIA, VA, 22313-1404, US

(21) Appl. No.: 08/174,353

(22) Filed: Dec. 28, 1993

(30) Foreign Application Priority Data
Dec. 28, 1992 (JP) 4-349023(PAT.)
Dec. 28, 1992 (JP) 4-349024(PAT.)

(51) Int. Cl. H04N 5/76; H04N 5/225

(52) U.S. Cl. 386/117; 348/208.99

(57) ABSTRACT

An image recording and reproducing system includes a recording device having an image recorder for recording an image of a subject on a recording medium, a detector for detecting information about deterioration of the subject image recorded on the recording medium, an information recorder for recording the detected deterioration information, and a reproducing device having an image reproducer for reproducing the subject image, a calculator for calculating a function indicative of a deterioration characteristic of the recorded subject image based on the recorded deterioration information, and a corrector for correcting the recorded subject image in accordance with the calculated deterioration characteristic.

### BACKGROUND OF THE INVENTION

This invention relates to an image recording and reproducing system, more particularly, to an image recording and reproducing system having an image recording device capable of recording a subject image on a recording medium with deterioration information and an image reproducing device capable of reproducing the recorded image while correcting the recorded image based on the deterioration information.

Various systems and arrangements have been proposed heretofore to compensate for shakes of a photographic camera and video camera. A known arrangement is to detect a vibration or shake of a camera by means of an angular velocity sensor, for example, and then control an optical system of the camera based on shake information to prevent blurring of a photographed image.

Another known arrangement especially devised for a video camera is to shift an image pickup area of an optical image sensor in response to a direction and speed of camera shake instead of controlling the optical system. According to this arrangement for the video camera, if a subject image once contained in a picture frame goes out of a specified image pickup area but still remains within the photosensitive surface of the optical image sensor, the image pickup area is shifted as much as the amount of image shift, making it possible to read out the same subject image.

In the prior art image recording and reproducing systems, however, shake compensation means is provided in the camera, not in the image reproducing apparatus. A major problem associated with the first arrangement mentioned above is that an increase in the size and weight of camera is inevitable as it requires a specially designed optical system and its drive mechanism for shake compensation. The second arrangement which cancels out the camera shake by shifting the image pickup area of the optical image sensor also has a problem in that the video camera becomes too expensive because a complicated control system and internal structure are required for detecting the amount of image shift and shifting the image pickup area by the same amount.

### SUMMARY OF THE INVENTION

It is an object of the present invention to provide an image recording and reproducing system which has overcome the problems residing in the prior art.

It is another object of the present invention to provide an image recording and reproducing system which can correct a deteriorated recorded image in a simplified construction.

An image recording and reproducing system of the present invention comprises a recording device including: first recording means for recording an image of a subject on a recording medium; detecting means for detecting information about deterioration of the subject image recorded on the recording medium by the first recording means; and second recording means for recording the detected deterioration information; and a reproducing device including: image reproducing means for reproducing the subject image recorded on the recording medium; calculating means for calculating a function indicative of a deterioration characteristic of the recorded subject image based on the recorded deterioration information; and correcting means for correcting the recorded subject image in accordance with the calculated deterioration characteristic.

Also, it may be appreciated to provide outputting means for outputting a predetermined image information; and correct the recorded subject image based on the detected deterioration information and the output image information.

Further, it may be appreciated to provide third recording means for recording information about an initial subject image immediately after starting the image recording; and correct the recorded image based on the recorded deterioration information and the recorded initial image information.

Furthermore, it may be preferable that the deterioration information has information about a shake of the recorded subject image. Also, it may be preferable that the image information has a specified constant value or the image information is determined based on the recorded subject image. Further, it may be preferable that the image reproducing means includes means for converting the recorded image to a video signal, and the correcting means includes means for processing the video signal to correct the recorded image.

Moreover, the present invention is directed to an image an image reproducing apparatus comprising: image reproducing means for reproducing an image recorded on a developed film; detecting means for detecting information about deterioration of the image recorded on the developed film; calculating means for calculating a function indicative of a deterioration characteristic of the recorded image based on the detected deterioration information; and correcting means for correcting the recorded image in accordance with the calculated deterioration characteristic. Also, it may be appreciated to provide outputting means for outputting a predetermined image information, and correct the recorded image based on the detected deterioration information and the output image information.

With these image recording and reproducing systems, an image deterioration caused by a shake or the like is detected and recorded as deterioration information on the recording medium. In reproducing recorded images, the recorded image is corrected based on the recorded deterioration information.

Accordingly, the present invention can eliminate the need of compensating a shake when recording or photographing a subject, and eliminate the need of additionally providing a deterioration correcting device on the image recording device. This makes it possible to produce small sized and light cameras at low costs. Also, image reproduction is performed based on recorded deterioration information. Accordingly, clearer images can be assuredly obtained.

The above and other objects, features and advantages of the invention will become more apparent after having read the following detailed disclosure of preferred embodiments, which are illustrated in the accompanying drawings.

### BRIEF DESCRIPTION OF THE DRAWINGS

FIG. 1 is a perspective view showing an overall construction of an image recording and reproducing system embodying the invention;

FIG. 2 is a perspective view showing a camera of the image recording and reproducing system;

FIG. 3 is a block diagram showing a construction of principal components of the camera;

FIG. 4 is a block diagram showing a construction of a shake detector provided in the camera;

FIG. 5 is a diagrammatic representation of an arrangement of pixels on a photosensitive surface of a charge-coupled device (hereinafter referred to as CCD) incorporated in the camera;

FIG. 6 is a graph showing a distribution of correlation values obtained from an image data correlation process;

FIGS. 7A to 7D are graphs showing results of correlation operation performed by the camera;

FIG. 8 is a graph showing a relationship between the amount of displacement of a subject image and shake detection timing;

FIG. 9A is a schematic diagram showing an illuminance monitoring circuit provided in the shake detector;

FIG. 9B is a schematic diagram showing another illuminance monitoring circuit provided in the shake detector;

FIG. 10 is a graph showing a change in the output of an integration circuit for controlling integration time of the CCD with respect to time;

FIG. 11 is a flowchart showing a photographing operation of the camera;

FIG. 12 is a flowchart showing a shake detecting operation of the shake detector;

FIG. 13 is a block diagram showing a construction of principal components of an image reproducing apparatus of the recording and reproducing system;

FIG. 14 is a diagram showing an original image to be reproduced with shake compensation;

FIG. 15 is a diagram showing a blurred image prior to shake compensation;

FIG. 16 is a diagram showing a blurred image picked up by a shake sensor having 5×5 pixels;

FIG. 17 is a diagram showing a blurred image picked up by a shake sensor having 4×4 pixels; and

FIG. 18 is a flowchart showing a reproducing operation of the image reproducing apparatus.

### DETAILED DESCRIPTION OF THE PREFERRED EMBODIMENT OF THE INVENTION

A preferred embodiment of the present invention will now be described referring to the accompanying drawings. An image recording and reproducing system of the embodiment is principally constructed by a camera carrying a silver salt film and an image reproducing apparatus for reproducing photographic images recorded on the film onto a TV monitor screen.

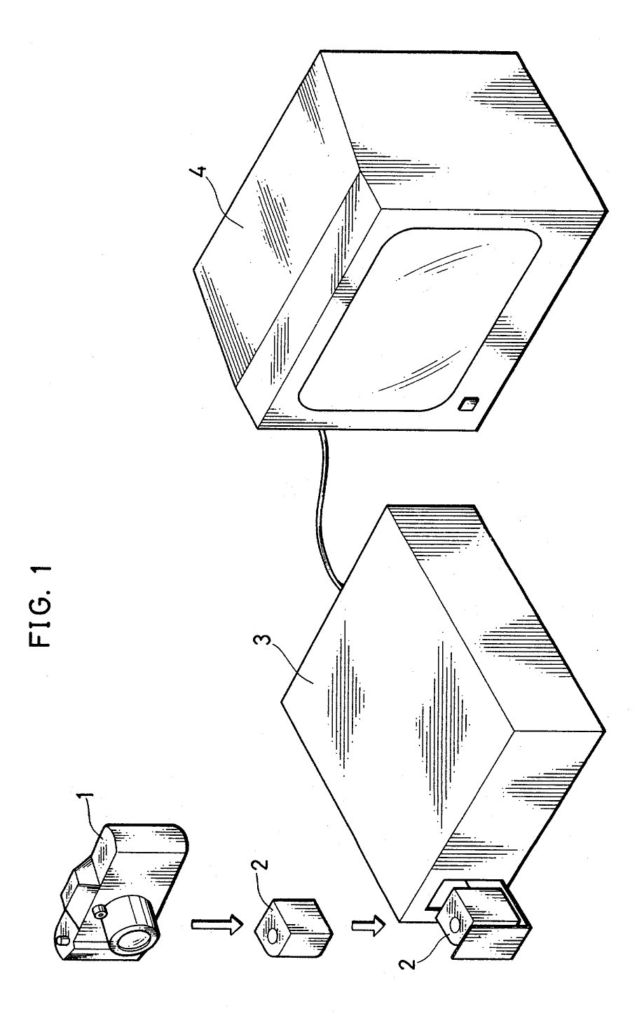

FIG. 1 is a perspective view showing an overall construction of the image recording and reproducing system. Indicated at reference number 1 is a camera capable of detecting camera shake and record shake information on a film together with photographed images. The shake information will be described later in detail.

After photographing, the film is developed and loaded in a film cartridge 2 in a laboratory before it is returned to the photographer. Indicated at reference number 3 is an image reproducing apparatus. When the film cartridge 2 is mounted on the image reproducing apparatus 3, an image recorded on the film is converted into electric signals through a photoelectric conversion process by the use of an area image sensor such as a CCD and displayed on a TV monitor 4.

The image reproducing apparatus 3 eliminates a camera shake using an image processing technique based on the shake information recorded on the film by the camera 1. As a result, the TV monitor 4 displays clear and steady pictures even if they were photographed with shaky hands.

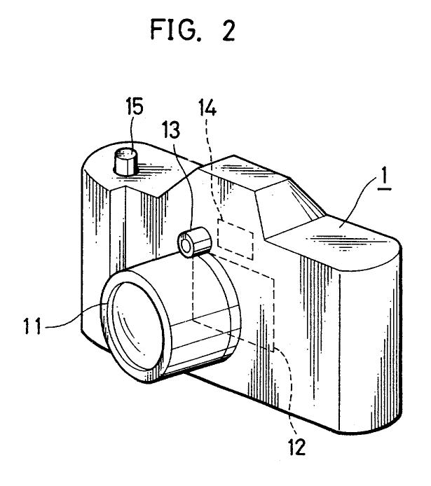

FIG. 2 shows a perspective view of the camera 1 capable of detecting a camera shake. The camera 1 is provided with an image pickup device for picking up a subject image which is used to produce camera shake information. The image pickup device includes a shake sensor 14 for picking up an image of the subject into electric signals through a photoelectric conversion process and a shake detecting optical system 13 for forming a light image of the subject on a photosensitive surface of the shake sensor 14. The shake detecting optical system 13 is located above a lens 11 for forming a subject image on a film plane 12 while the shake sensor 14 is provided behind the shake detecting optical system 13 on a common optical axis.

Indicated at reference number 15 is a two-stroke shutter release button which initiates light and distance measuring process in a first stroke and releases shutter in a second stroke. Interlocked with the strokes of the shutter release button 15, switches S1 and S2 are turned on and off individually.

When the switch S1 is turned on, the measurement is started of the incident light intensity and distance to the subject for both automatic exposure setting and automatic focusing. When the switch S2 is turned on, the photography is executed at a set exposure value. On the other hand, the shake sensor 14 successively picks up a plurality of images of the same subject at a specified interval during the exposure. Shake information for each shot is derived from the images picked up by the shake sensor 14. A calculating process for obtaining shake information will be described later in detail.

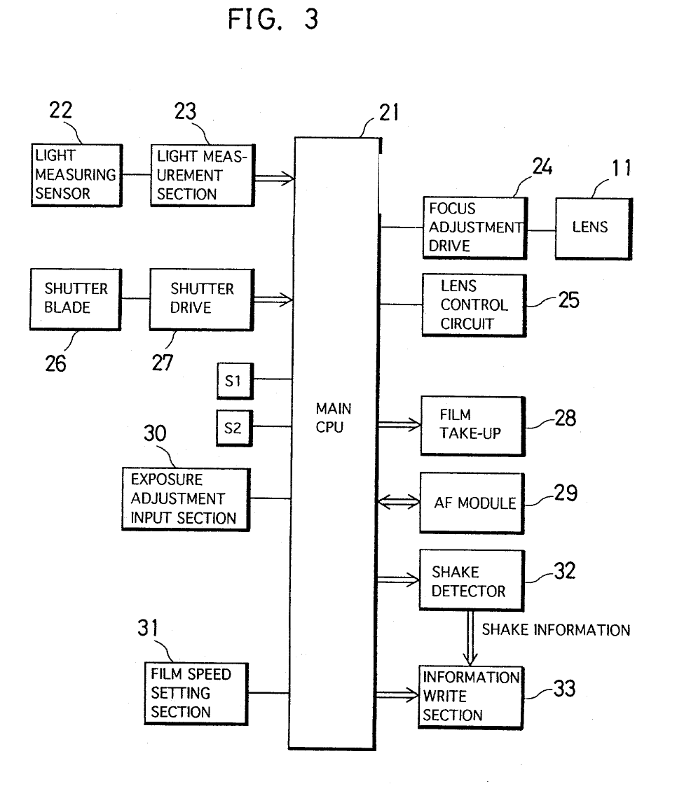

FIG. 3 is a block diagram showing a construction of principal components of the camera 1. Indicated at reference number 21 is a main CPU for an overall control of the camera 1. A light measuring sensor 22 comprising a silicon photodiode (or an SPD) and a light measurement section 23 are for measuring brightness of the subject. Based on a brightness signal received from the light measuring sensor 22, the light measurement section 23 calculates a light measurement value, which is then delivered to the main CPU 21.

The camera 1 further includes a focus adjustment drive 24 for adjusting the focal length of the lens 11, a lens control circuit 25 for storing parameters representative of properties of the lens 11 including F-number and focal length f, a shutter drive 27 for driving a shutter blade 26, a film take-up 28 for taking up and rewinding a film loaded in the camera 1, and an automatic focusing module (hereinafter referred to as AF module) 29 for measuring the distance to a subject to determine a suitable focal length. The switch S1 is turned on in the first stroke of the shutter release button 15 to start the light measurement and automatic focusing operations. The switch S2 is turned on in the second stroke of the shutter release button 15 to initiate the shutter release action. An exposure adjustment input section 30 performs correction to the exposure value determined by the main CPU 21 based on the result of light measurement by the light measurement section 23. A film speed setting section 31 is for setting a film speed (or sensitivity) of the film loaded in the camera 1. For instance, the film speed setting section 31 obtains film speed information by reading a bar code marked on a film cassette and send this information to the main CPU 21.

A shake detector 32 determines amounts of shift or displacement of a subject image formed on the film by the lens 11. As will be described later, the shake detector 32 successively detects image forming positions at a specified sampling interval during the exposure. Successive image forming positions are compared with an initial image forming position, or the position of the subject image picked up immediately after the start of exposure. From this comparison, the shake detector 32 detects a shift of the subject image and calculates the amount of shift every sampling interval. Subsequently, an information write section 33 records the calculation result, or shake information of the photographed image, on a magnetic recording area provided on the film outside its picture frame, for example. Alternatively, the shake information may be optically recorded outside the picture frame of the film. In addition to the shake information obtained by the shake detector 32, the information write section 33 also records associated photographic information such as the date and exposure value on the film. The photographic information may also be recorded either optically or magnetically.

Various types of optical and magnetic recording of information on a film have been known. Accordingly, in this specification, a detailed description of information recording on film is omitted because the present invention is not directed to such field of technology.

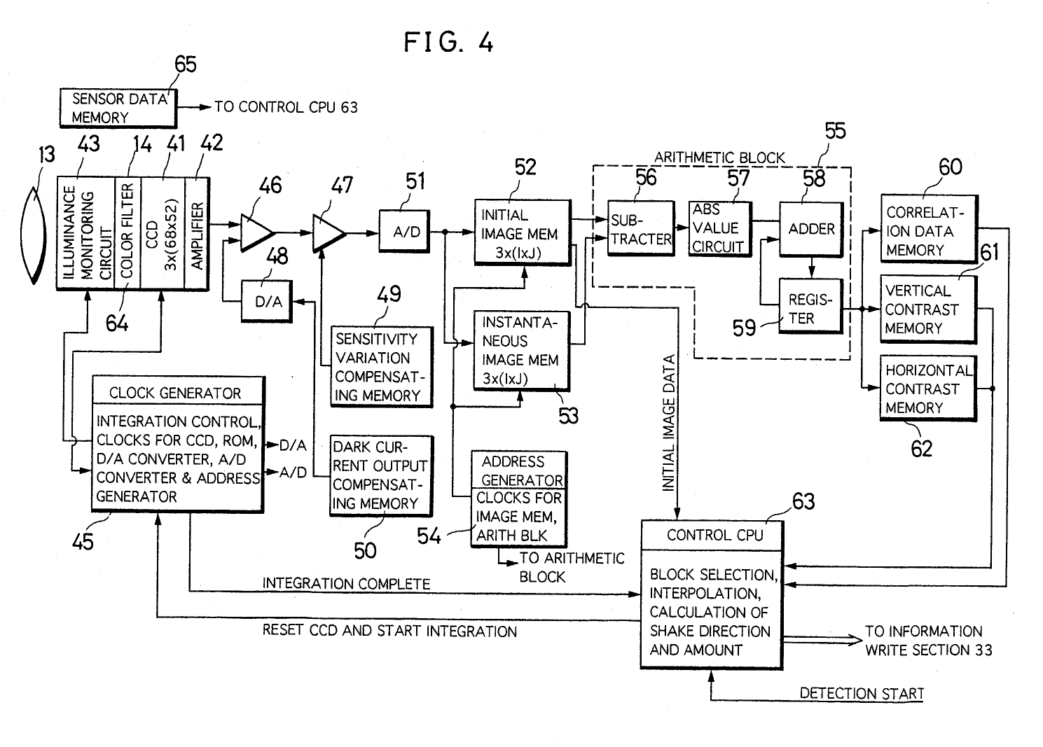

Referring now to FIG. 4, a construction and operation of the shake detector 32 will be described. The shake sensor 14 comprises a CCD 41 for picking up a subject image, an amplifier 42 for amplifying image signals outputted from the CCD 41, and an illuminance monitoring circuit 43 for monitoring the brightness of the subject.

The charge accumulating time or integration time of the CCD 41 is controlled by a clock generator 45. Associated with a color filter 64 for separating incident light into red, green and blue primary colors, the CCD 41 converts the red, green and blue components into respective electric signals and outputs these signals to the amplifier 42.

The shake sensor 14 is also provided with a sensor data memory 65 for storing such data as the number of pixels, pixel pitch and image pickup area of the CCD 41 as well as the focal length of the shake detecting optical system 13.

The information write section 33 writes these data on the film in accordance with a control signal from the control CPU 63. The written data are used for camera shake compensation in the image reproducing apparatus as be described later. The shake detecting optical system 13 includes a single focus lens, of which focal length is fd, for forming a subject image on the surface of the CCD 41.

Alternatively, the shake detecting optical system 13 may be an optical system which introduces the same subject image both to the film and to the CCD 41. Also, it may be possible to use an optical system for introducing an enlarged image of a part of the subject image, a center portion of the subject image, to the CCD 41. Generally, the CCD 41 provides a higher resolution and more accurate detection of camera shake when a partially enlarged image is introduced thereupon because a greater number of pixels are used to pick up the same portion of the subject image than the whole subject image being introduced.

The clock generator 45 generates clock signals for the CCD 41, a D/A converter 48, a sensitivity variation compensating memory 49 and a dark current output compensating memory 50 and an A/D converter 51. The clock generator 45 also generates a control signal for controlling the charge accumulating time of the CCD 41 based on a signal about the incident light intensity of the subject image fed from the illuminance monitoring circuit 43.

A differential amplifier 46 compensates signal levels derived from individual pixels (hereinafter referred to as pixel signals) of the CCD 41 for dark current output levels. A gain control amplifier 47 compensates the pixel signals for output level differences due to sensitivity variations of the individual pixels. Data for compensating for sensitivity variations and dark current output levels are stored in the sensitivity variation compensating memory 49 and dark current output compensating memory 50, respectively. The D/A converter 48 converts dark current compensating data read from the dark current output compensating memory 50 from digital to analog form and delivers a resultant analog signal to the differential amplifier 46.

When the CCD 41 has picked up a subject image, individual pixel signals composing the subject image are sequentially read into the differential amplifier 46. Synchronized with this process, the dark current compensating data is read from the dark current output compensating memory 50, D/A-converted by the D/A converter 48 and sent to the differential amplifier 46. Then, the differential amplifier 46 subtracts dark current output levels from the individual pixel signals to cancel out dark current components.

After the dark current compensating process, the individual pixel signals are sent to the gain control amplifier 47. Synchronized with the incoming pixel signals, the gain control amplifier 47 reads sensitivity variation data from the sensitivity variation compensating memory 49, and gain of the gain control amplifier 47 is set in accordance with the sensitivity variation data. The pixel signals are compensated for sensitivity variations among the individual pixels as their output levels are adjusted by properly controlled gain of the gain control amplifier 47.

The pixel signals outputted from the gain control amplifier 47 are converted from analog to digital form by the A/D converter 51 and stored in an initial image memory 52 and an instantaneous image memory 53 or only in the instantaneous image memory 53. More particularly, the initial image memory 52 is adapted for storing pixel data of an initial image, or a subject image picked up immediately after the start of each exposure, to be used as a reference for detecting image shifts during the exposure.

On the hand, the instantaneous image memory 53 is adapted for successively storing pixel data of instantaneous images picked up at a specified sampling interval after the start of each exposure. Pixel data stored in the instantaneous image memory 53 is updated and compared with pixel data of the initial image every sampling interval to calculate the amount of image shift.

The initial image memory 52 and instantaneous image memory 53 each have three memory areas for storing pixel data for red, green and blue components of a subject image.

An address generator 54 generates address data for controlling storage of pixel data of the initial image and instantaneous images into the initial image memory 52 and instantaneous image memory 53.

Also, provided in the shake detector 32 is an arithmetic block 55 comprising a subtracter 56, an absolute-value circuit 57, an adder 58 and a register 59. The arithmetic block 55 performs mathematical operations to obtain correlation data, vertical contrast data and horizontal contrast data which will be required in a subsequent shake compensating procedure. The correlation data, vertical contrast data and horizontal contrast, which will be described later in detail, are stored in a correlation data memory 60, a vertical contrast memory 61 and a horizontal contrast memory 62, respectively.

The control CPU 63 works as a central controller for individual components of the shake detector 32. Controlled by the control CPU 63, the clock generator 45 produces a drive signal that causes the CCD 41 to pick up subject images to be used for detecting shake information, and the address generator 54 produces address data to specify locations in the initial image memory 52 and instantaneous image memory 53 for storing the initial image data and instantaneous image data derived from the images picked up by the CCD 41. Further, the control CPU 63 processes the data stored in the correlation data memory 60, vertical contrast memory 61 and horizontal contrast memory 62 to obtain the shake information.

Next, the operation of camera shake detection will be described below. According to the present invention, camera shake is detected by the use of the red, green and blue components of a subject image. The following description covers a procedure for detecting camera shake from the red component. Camera shake detection with the green and blue components takes substantially the same procedure as described below.

The red component of the subject image separated by the color filter 64 is converted into two-dimensional image data by the CCD 41. The image data is then processed to find out the amount of shift or displacement of the red component image with the lapse of time.

Generally, camera shake detection is carried out in the following sequence: (1) block selection, (2) correlation operation, and (3) interpolation operation.

First, the image pickup area of the CCD 41 is divided into small regions, which are referred to as blocks in the following description. An image formed on the surface of the CCD 41 contains portions suited for camera shake detection as well as portions unsuited for the same. In the block selection process, a plurality of blocks suited for camera shake detection is selected. The CCD 41 is an area image sensor composed of a matrix of photosensitive elements or pixels. In the following description, it is assumed that the CCD 41 has on its photosensitive surface I×J pixels responsive to the red component of incident light, and the image pickup area of the CCD 41 is divided into M×N blocks each containing K×L pixels. Blocks that provide higher contrast of the subject image are selected for camera shake detection. These blocks are referred to as shake detecting blocks in the following.

The initial image memory 52 and instantaneous image memory 53 each have a capacity of I×J words for the red component corresponding to the I×J pixels of the CCD 41. On the other hand, the vertical contrast memory 61 and horizontal contrast memory 62 each have a capacity of M×N words for the red component. It is to be noted that the initial image memory 52, instantaneous image memory 53, vertical contrast memory 61 and horizontal contrast memory 62 each have the same capacity for the green and blue components as well.

In the process of correlation operation, instantaneous images successively picked up by the CCD 41 are individually compared with the initial image in every shake detecting block chosen in the block selection process. To compare one instantaneous image with the initial image in one shake detecting block, initial image data is sampled from all K×L pixels contained in the shake detecting block in question. On the other hand, instantaneous image data is sampled not only from the same sampling area as the initial image but from those areas which are offset from the initial image sampling area by specified numbers of pixels. Thus, instantaneous image data taken from a plurality of sampling areas are compared with initial image data sampled from the shake detecting block. Obtained from this comparison are a set of correlation values which represent degrees of similarity between the initial image and instantaneous image within the shake detecting block. The smaller the deviation between the initial image and instantaneous image, the smaller the correlation value. It is assumed, therefore, that the instantaneous image of the subject was formed where a minimum correlation value is obtained. Accordingly, the amount of image shift is given by the deviation between the initial image sampling area and the instaneous image sampling area providing the minimum correlation value.

Provided that the instantaneous image sampling area is offset by N pixels when the correlation value becomes minimum, the deviation equals the product of pixel pitch P of the CCD 41 and the number of pixels N.

Image data correlation is made for all the selected shake detecting blocks. When the instantaneous image sampling area coincides with the initial image sampling area, output signals from all the K×L pixels in a shake detecting block are compared between the instantaneous image and the initial image.

When the instantaneous image sampling area is offset from the initial image sampling area by ±h pixels (where h=1, 2, . . . ), comparison between the instantaneous image and initial image is made in different ways depending on whether they are offset horizontally or vertically.

In case the instantaneous image sampling area is horizontally offset from the initial image sampling area by +m pixels, output signals from (K−m)×L pixels are compared between the instantaneous image and the initial image. More particularly, an initial image signal from one pixel is compared with an instantaneous image signal from a pixel horizontally separated from that pixel by as much as +m pixels. Similarly, when the instantaneous image sampling area is vertically offset from the initial image sampling area by +n pixels, output signals from K×(L−n) pixels are compared between the instantaneous image and the initial image. More particularly, an initial image signal from one pixel is compared with an instantaneous image signal from a pixel vertically separated from that pixel by as much as +n pixels.

As seen above, correlation values are calculated for a plurality of instantaneous image sampling areas separated by as much as h pixels (where h=0, ±1, ±2, . . . ). Provided that the number of correlation values calculated by the correlation operation is H, the correlation data memory 60 has a capacity of H×H words individually for the red, green and blue components.

In the process of interpolation operation, correlation values obtained by the foregoing correlation operation are interpolated in order to estimate the true amount of image shift or deviation between the initial image and each instantaneous image of the subject. In the correlation process, if an instantaneous image sampling area offset by h pixels from the initial image sampling area gives a minimum correlation value, the amount of image shift is estimated to be equal to the distance corresponding to the h pixels. It would be understood from this that the amount of image shift estimated from correlation values cannot have a resolution better than the pixel pitch P of the CCD 41. For instance, if a position of the instantaneous image sampling area providing a minimum correlation value deviates from the true position of the instantaneous image by an amount not exceeding the pixel pitch P, the estimated amount of image shift contains a corresponding error. The interpolation operation is done to estimate the true position of the instantaneous image by using a plurality of correction values to reduce errors related to the pixel-pitch resolution.

In describing the camera shake compensating sequence of this embodiment, it is assumed that I=68, J=52, K=8, L=8, M=8, N=6 and H=5. it is further assumed that the A/D converter 51 has an 8-bit resolution, the register 59 has a 14-bit resolution, and the correlation data memory 60, vertical contrast memory 61 and horizontal contrast memory 62 each have a word length of 14 bits.

FIG. 5 is a diagrammatic representation of the arrangement of pixels responsive to the red component on the photosensitive surface of the CCD 41. In FIG. 5, small squares shown by thin lines represent individual pixels and these pixels are divided into medium-sized square blocks shown by thick lines. The lower-left pixel is referred to as pixel P1,1 and the upper-right pixel is referred to as pixel P68,52. Further, the lower-left block is referred to as block B1,1 and the upper-right block is referred to as block B8,6. As already described, each block designated Bk,l (where k=1 to 8, l=1 to 6) contains 8×8 pixels designated Pi,j (where i=8k−5 to 8k+2, j=8l−5 to 8l+2).

As shown in FIG. 5, two outermost rows and columns of pixels on the four sides of the CCD 41 are not included in any blocks. This is to allow the correlation operation to be done using those peripheral pixels around individual blocks. In this embodiment, the instantaneous image sampling area is offset by ±2 pixels at the maximum in executing the correlation operation. This is why the blocks are arranged excluding two pixel widths of marginal regions. Generally, if the instantaneous image sampling area is allowed to offset by ±h pixels at the maximum, there should be provided at least h pixel width of marginal regions.

Now, the camera shake compensating sequence including the aforementioned three processes (1) to (3) for the red component is described below in further detail.

A) Block Selection

First, contrast of a subject image is assessed in a quantitative manner to find out blocks suited for camera shake detection. This is performed by calculating the contrast of the subject image contained in all blocks. Then, eight shake detecting blocks, of which four have larger vertical contrast values and the remaining four have larger horizontal contrast values, are selected.

More particularly, the image data output of the CCD 41 is stored in both the initial image memory 52 and instantaneous image memory 53 at the beginning. Vertical and horizontal contrast values for each block are calculated using this image data.

Calculation of vertical contrast of the subject image in each block Bk,l (where k=1 to 8, l=1 to 6) comprises the following steps:

(1) Data in the register 59 is cleared;

(2) The address generator 54 generates address data which causes the initial image memory 52 to transmit pixel data P8k−5, 8l−5 to one of the inputs of the subtracter 56, and the instantaneous image memory 53 to transmit pixel data P8k−5, 8l−4 to the other input of the subtracter 56;

(3) The subtracter 56 performs subtraction between the two pixel data and the result of subtraction outputted from the subtracter 56 is absolutized in the absolute-value circuit 57; and

(4) The adder 58 adds the absolutized data to existing data in the register 59.

As the address generator 54 generates address data, steps (2) through (4) above are repeated, sequentially moving from one pixel to another. At the end of this cyclical process, the register 59 retains vertical contrast value VCk,l for block Bk,l. The vertical contrast value VCk,l for block Bk,l can be stated as the following equation;

$$Vck , 1 = {\sum }_{j = 8 l - 5}^{8 l + 1} {\sum }_{i = 8 k - 5}^{8 k + 2} \vert Pi , j - Pi , j + 1 \vert \qquad ( 1 )$$

The vertical contrast value VCk,l for block Bk,l retained in the register 59 is transferred to and stored in an appropriate address in the vertical contrast memory 61. By repeating operations (1) through (4) described above, vertical contrast values for all blocks are obtained and stored in the vertical contrast memory 61 in sequence.

Horizontal contrast of the subject image in each block is calculated by following substantially the same steps as used for calculation of vertical contrast as the address generator 54 generates appropriate address data. Subsequently, the register 59 retains horizontal contrast value HCk,l for block Bk,l, which is expressed by:

$$HCk , 1 = {\sum }_{j = 8 l - 5}^{8 l + 2} {\sum }_{i = 8 k - 5}^{8 k + 1} \vert Pi , j - Pi + 1 , j \vert \qquad ( 2 )$$

The horizontal contrast value HCk,l for block Bk,l retained in the register 59 is transferred to and stored in an appropriate address in the horizontal contrast memory 62.

The control CPU 63 selects blocks referring to the vertical and horizontal contrast values obtained in the above procedure. More particularly, the control CPU 63 selects four blocks having larger vertical contrast values plus four blocks having larger horizontal contrast values among 48 (8×6) blocks. These blocks, eight in all, are designated blocks B1 to B8.

After block selection, the control CPU 63 reads out pixel data of the initial image stored in the initial image memory 52 and outputs it to the information write section 33. The information write section 33 writes the pixel data of the initial image on the film when the film is rewound and the pixel data of the initial image written on the film is referred to as the initial image data. The initial image data is read out by the image reproducing apparatus 3 when reproducing images recorded on the film, and used for image processing required for accurate camera shake compensation.

It is to be pointed out in the above connection that the initial image data to be recorded on the film may be either the whole or a specified portion of the pixel data stored in the initial image memory 52. The initial image data recording operation will be described later in greater detail.

B) Correlation Operation

Now, the process of correlation operation is described in detail. At the end of the block selection process described above, the initial image memory 52 still retains the pixel data of the initial image. On the other hand, pixel data of an instantaneous image is sequentially outputted from the CCD 41 and stored in the instantaneous image memory 53. Each time instantaneous image pixel data in the instantaneous image memory 53 is refreshed, it is compared with the initial image pixel data to evaluate the displacement of the subject image. The amount of relative displacement between two images stored in the initial image memory 52 and instantaneous image memory 53 is calculated by the correlation and interpolation operations described in the following.

The result of image data correlation (or correlation value) for block Bk,l is given by:

$$Ck , 1 ( m , n ) = {\sum }_{J = 8 l - 5}^{8 l + 2} {\sum }_{i = 8 k - 5}^{8 k + 2} \vert Si , j - Ri + m , j + n \vert \qquad ( 3 )$$

(where m, n=0, ±1, ±2) where Si,j is pixel data of pixel Pi,j at coordinates (i, j) stored in the initial image memory 52 while Ri,j is pixel data of pixel Pi,j coordinates (i, j) stored in the instantaneous image memory 53. Now, denoting correlation values of the eight blocks B1 to B8 selected in the aforementioned block selection process by C1(m, n) to C8(m, n), the sum of these correlation values is defined as:

$$C ( m , n ) = {\sum }_{k = 1}^{8} Ck ( m , n ) \qquad ( 4 )$$

(where m, n=0, ±1, ±2)

To carry out the correlation operation, pixel data Si,j of pixel Pi,j stored in the initial image memory 52 is delivered to one of the inputs of the subtracter 56 and pixel data Ri+m, j+n of pixel Pi+m,j+n stored in the initial image memory 52 is delivered to the other input of the subtracter 56. As the address generator 54 sequentially generates appropriate address data, the value C(m, n) is stored in the register 59 and then transferred to and stored in a specified address of the correlation data memory 60. The above operation is carried out for every combination of values of m and n (where m, n=0, ±1, ±2) and 25 (5×5) correlation values C(m, n) are stored in the correlation data memory 60.

C) Interpolation Operation

Next, the process of interpolation operation is described in detail.

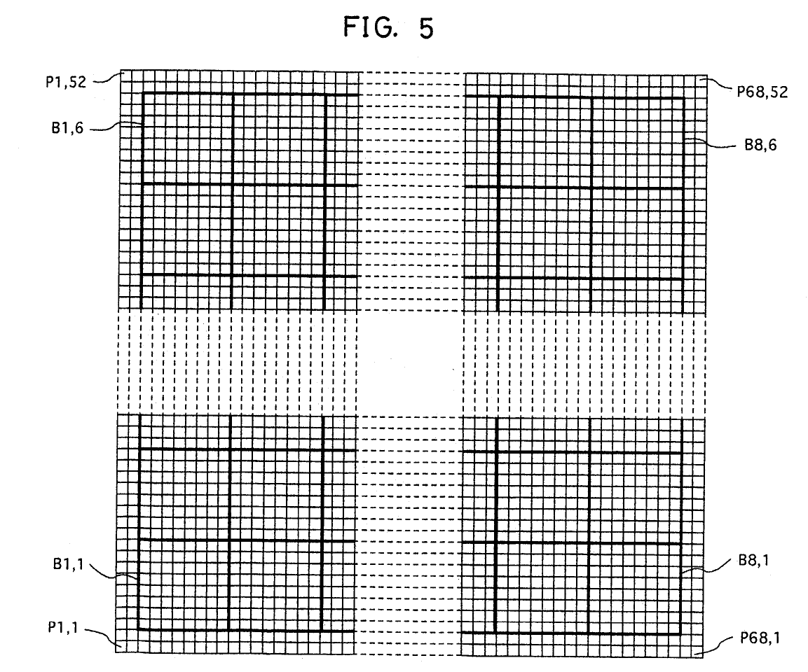

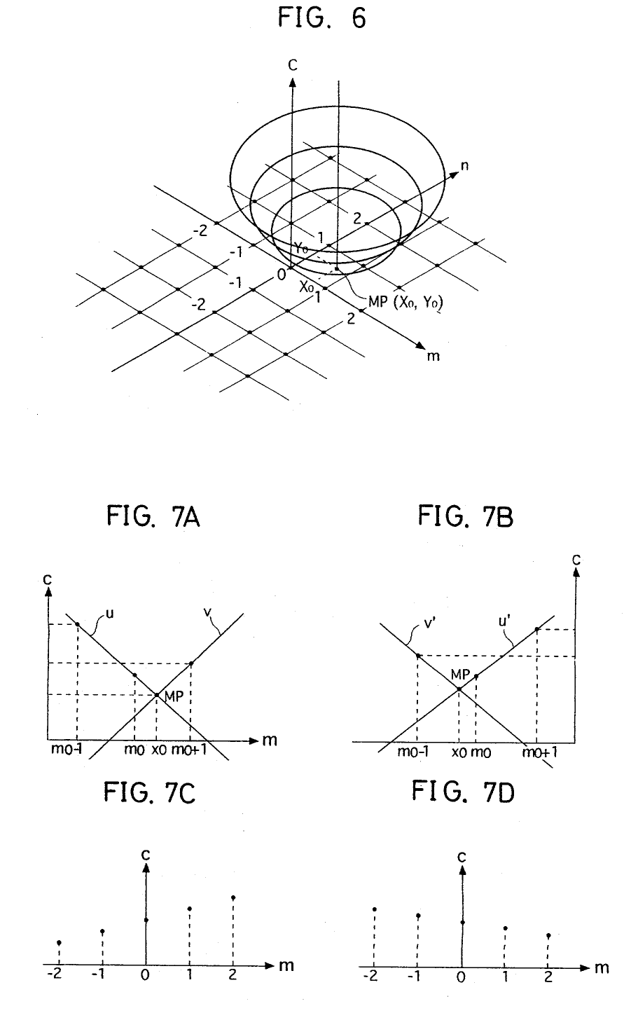

FIG. 6 is a graph showing a distribution of correlation values C(m, n) obtained from the aforementioned image data correlation process. If there is no relative displacement between the initial image and instantaneous image, the correlation value is C(0, 0)=0. The correlation value becomes larger as it is separated further away from the point of C(0, 0)=0. If the instantaneous image is displaced m0 pixels rightward and n0 pixels upward from the initial image, C(m0, n0)=0 and the more separated from this point, the larger the correlation value.

It would however be understood that the amount of image shift does not necessarily equal the product of the pixel size and an integer. FIG. 6 shows a distribution of correlation values C(m, n) obtained in such a case. Referring to FIG. 6, correlation values actually obtained by Equation (4) are shown by dots at lattice intersections. On the assumption that there also exist correlation values between these dots, those points which supposedly have the same correlation values are connected together by contour lines. Coordinates of the center of the contour lines are (X0, Y0) and it is assumed that C(X0, Y0)=0 at this point.

The control CPU 63 carries out the interpolation operation using the correlation values C(m, n) (where m, n=0, ±1, ±2) stored in the correlation data memory 60 to calculate the amount of shift (X0, Y0) of the instantaneous image with respect to the initial image. Given below is a detailed description of this calculating process.

First, the control CPU 63 searches for the minimum value C(m0, n0) of the correlation values C(m, n). Among the lattice points plotted in FIG. 6, point (m0, n0) is supposed to be closest to point (X0, Y0).

Next, to find out the value of X0, the control CPU 63 determines, based on a comparison between a pair of correlation values C(m0−1, n0) and C(m0+1, n0), which one of the following cases (a) to (d), the horizontal distribution of correlation values falls within. Four possible horizontal distributions of correlation values stated in the cases (a) to (d) below are graphically depicted in FIGS. 7A to 7D, respectively.

(a) m0=0 or ±1, and C(m0−1, n0)≧C(m0+1, n0) In this case, it is judged that m0≦X0<m0+1. Referring to FIG. 7A, the intersection of line u passing through points (m0−1, C(m0−1, n0)) and (m0, C(m0, n0)) and line v passing through point (m0+1, C(m0+1, n0)) at an inverted slope with respect to the line u is obtained. The coordinate of the intersection taken on the m-axis gives the value of X0. In calculating the value of X0, the control CPU 63 performs an operation expressed by the following equation:

$$X0 = m0 + \frac{1}{2} \times \frac{C ( m0 - 1 , n0 ) - C ( m0 + 1 , n0 )}{C ( m0 - 1 , n0 ) - C ( m0 , n0 )} \qquad ( 5 )$$

(b) m0=0 or ±1, and C(m0−1, n0)<C(m0+1, n0)

In this case, it is judged that m0−1≦X0<m0. Referring to FIG. 7B, the intersection of line u′ passing through points (m0+1, C(m0+1, n0)) and (m0, C(m0, n0)) and line v′ through point (m0−1, C(m0−1, n0)) at an inverted slope with respect to the line u′ is obtained. The coordinate of the intersection taken on the m-axis gives the value of X0. In calculating the value of X0, the control CPU 63 performs an operation expressed by the following equation:

$$X0 = m0 + \frac{1}{2} \times \frac{C ( m0 - 1 , n0 ) - C ( m0 + 1 , n0 )}{C ( m0 + 1 , n0 ) - C ( m0 , n0 )} \qquad ( 6 )$$

(c) m0=−2

In this case, it is judged that a maximum image shift which is considered practically possible has occurred and that it is impossible to determine the amount of image shift.

(d) m0=2

In this case, it is also judged that a maximum image shift which is considered practically possible has occurred and that it is impossible to determine the amount of image shift.

The amount of image shift X0 in the horizontal direction is calculated by the above procedure. Similarly, the control CPU 63 classifies the vertical distribution of correlation values based on a comparison between a pair of correlation values C(m0, n0−1) and C(m0, n0+1) and calculates the amount of image shift Y0 in the vertical direction.

The amount of horizontal shake X0 and the amount of vertical shake Y0 of the red component of the subject image are calculated by executing the aforementioned operations including A) Block Selection, B) Correlation Operation, and C) Interpolation Operation. Amounts of horizontal and vertical shakes of the green and blue components of the subject image are also obtained in substantially the same manner as described above.

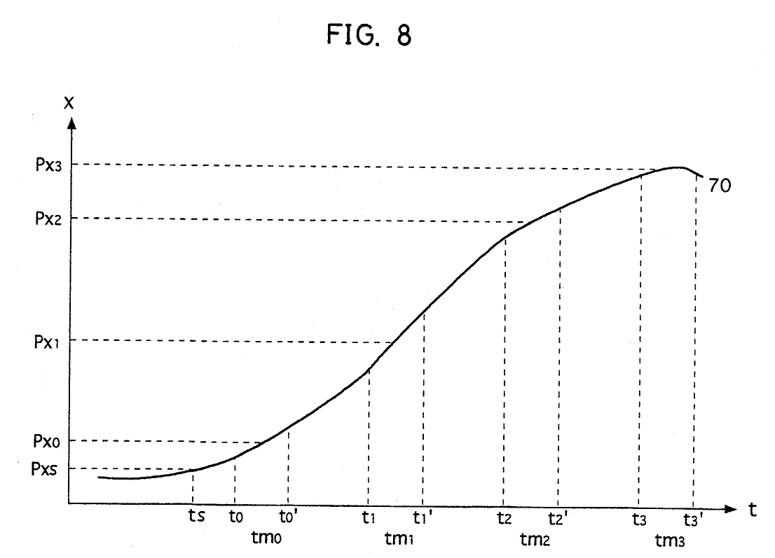

Referring now to FIG. 8, shake detection timing and recording of shake information are described. FIG. 8 is a graph showing a relationship between the amount of displacement of the red component of the subject image and camera shake detection timing. The horizontal axis t indicates time and the vertical axis x indicates horizontal shift of the subject image. The following description deals only with horizontal shakes since substantially the same description applies to vertical shakes.

In FIG. 8, t0, t1, t2, t3 and so on denote integration start times of the CCD 41 while t0′, t1′, t2′, t3′ and so on denote its integration end times. Indicated at reference number 70 is a curve indicating instantaneous location of the subject image formed on the sensitive surface of the CCD 41. Point Pxs represents the position of the subject image at exposure start time t=ts.

Points Px0, Px1, Px2, Px3 and so on indicate average positions of the subject image on the CCD 41 during integration time periods t0 to t0′, t1 to t1′, t2 to t2′, t3 to t3′ and so on. By approximation, average positions of the subject image in individual integration time periods are considered to be equal to the positions at midpoints of respective integration time periods, i.e., tm0=(t0′+t0)/2, tm1=(t1′+t1)/2, tm2=(t2′+t2)/2, tm3=(t3′+t3)/2 and so on.

In the preferred embodiment, the CCD 41 of the camera performs a first cycle of integration for a time period of t0 to t0′ immediately following the start of exposure at time ts. Image data derived from the first cycle of integration is typically the same as the earlier mentioned initial image data. Outputted from the CCD 41, the initial image data is stored in both the initial image memory 52 and instantaneous image memory 53. This data is used for executing the aforementioned contrast assessment and block selection operations.

Image data derived from the second cycle of integration and onward, integration time periods being t1 to t1′, t2 to t2′, t3 to t3′ and so on, are sequentially stored in the instantaneous image memory 53 overwriting previous data. On the other hand, the initial image memory 52 retains the initial image data stored at the first cycle of integration. When image data is outputted from the CCD 41 after each cycle of integration, the amount of image shift is calculated.

More specifically, calculation of horizontal shakes of the subject image Px1−Px0, Px2−Px0, Px3−Px0 and so on as well as vertical shakes of the subject image Py1−Py0, Py2−Py0, Py3−Py0 and so on (not illustrated) is successively performed using new image data read out from the instantaneous image memory 53 and the initial image data read out from the initial image memory 52.

The information write section 33 is primarily to record on a film a combination of elapsed time data and the amount of image shift at every point of elapsed time. Strictly speaking, the amount of image shift at every point of elapsed time in each integration period is an averaged displacement of the subject image from its position at exposure start time ts as shown by Equation (7) below:

$$\begin{matrix} & Time & Horizontal & Vertical \\ & & shake & shake \\ Shake data 0 \text{:} & tm0 - ts & Px0 - Pxs & Py0 - Pys \\ Shake data 1 \text{:} & tm1 - ts & Px1 - Pxs & Py1 - Pys \\ Shake data 2 \text{:} & tm2 - ts & Px2 - Pxs & Py2 - Pys \\ Shake data 3 \text{:} & tm3 - ts & Px3 - Pxs & Py3 - Pys\end{matrix} \qquad ( 7 )$$

In this embodiment, the information write section 33 records the following combinations of data assuming that tm0≈ts, Px0≈Pxs and Py0≈Pys:

$$\begin{matrix} & Time & Horizontal & Vertical \\ & & shake & shake \\ Shake data 0 \text{:} & 0 & 0 & 0 \\ Shake data 1 \text{:} & tm1 - t0 & Px1 - Px0 & Py1 - Py0 \\ Shake data 2 \text{:} & tm2 - t0 & Px2 - Px0 & Py2 - Py0 \\ Shake data 3 \text{:} & tm3 - t0 & Px3 - Px0 & Py3 - Py0\end{matrix} \qquad ( 8 )$$

By introducing the above described approximation, “shake data 0” is made all zeroes.

Time data (t), horizontal shake data (X) and vertical shake data (Y) for the red component of the subject image are obtained by the procedure described above. The same procedure can be used to obtain time data, horizontal shake data and vertical shake data for the green and blue components. These data are recorded on the film as shake information by the information write section 33 when the film is rewound. Initial image data for the red, green and blue components are read from the initial image memory 52 and transferred to the information write section 33 following the already mentioned block selection process. In addition to the shake data, the information write section 33 records the initial image data on the film when it is rewound.

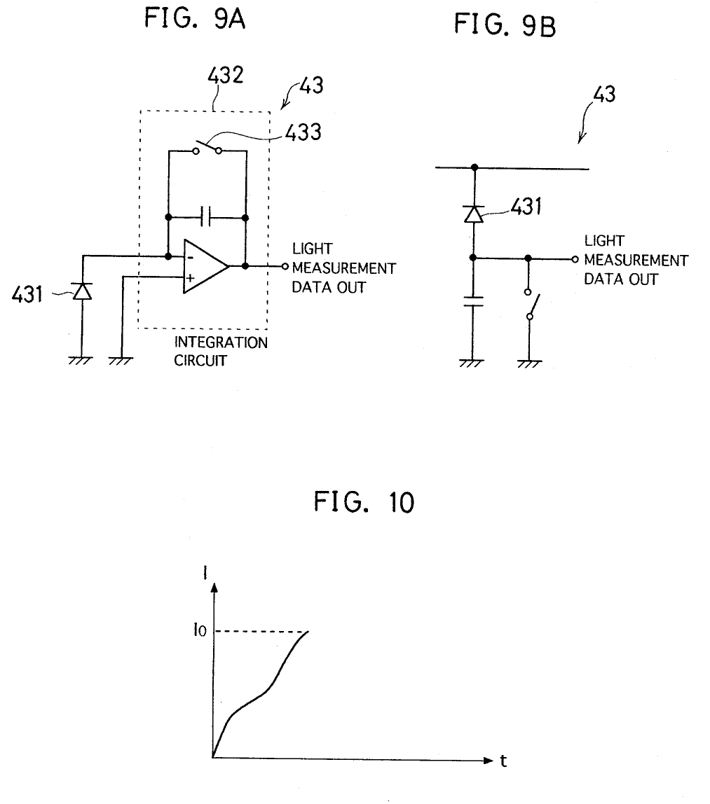

Described below is how integration time of the CCD 41 is controlled. FIG. 9A is a schematic diagram showing a construction of the illuminance monitoring circuit 43. The illuminance monitoring circuit 43 comprises a photosensor 431 including an SPD and an integration circuit 432 for integrating an input current from the photosensor 431 and outputting an integral of the current. The integration circuit 432 has an internal reset switch 433 for resetting the integral of the current.

The photosensor 431 converts incident light from a subject into an electric current proportional to the illuminance of the subject through a photoelectric conversion process. The integration circuit 432 integrates the current that flows into it from the photosensor 431 over a specified period and outputs the integral of the current to the clock generator 45. The output current of the integration circuit 432 is proportional to the amount of received light and electric charges carried by the output current per unit time is proportional to the illuminance of the subject.

The illuminance monitoring circuit 43 is used mainly to monitor the illuminance of a subject and stabilize the amount of electric charges accumulated in the CCD 41 even when the subject is illuminated by an AC-powered light source such as fluorescent lamp. When photographing a subject illuminated by an AC-powered light source, the amount of electric charges accumulated in the CCD 41 will fluctuate if its integration time period is kept at a fixed value. This problem will be described in detail later.

It is essential to adjust the integration time period depending on the illuminance level of the subject in order to stabilize the amount of electric charges accumulated in the CCD 41. In this embodiment, the integration circuit 432 of the illuminance monitoring circuit 43 starts the integration in synchronism with the start of each integration time period of the CCD 41. The integration end timing of the CCD 41 is controlled based on the output current of the integration circuit 432. FIG. 9B shows a modification of the illuminance monitoring circuit 43.

Referring again to FIG. 9A, described below is how the integration time of the CCD 41 is controlled in the camera shake detecting sensor.

When the internal reset switch is turned on, the integration circuit 432 is reset and electric charges accumulated in the CCD 41 are cleared. When an integration operation of the CCD 41 begins, the reset switch is turned off, causing the integration circuit 432 to start the integration.

FIG. 10 is a graph illustrating how the output of the integration circuit 432 varies with the lapse of time, where the horizontal axis t indicates integration time and the vertical axis I indicates the output level of the integration circuit 432. When the subject is illuminated by an AC-powered light source, the output level of the integration circuit 432 rises following an ascending curve like the one shown in FIG. 10. While the output level of the integration circuit 432 increases, it is compared with a properly set reference value I0. When the output I of the integration circuit 432 equals to this reference value I0, the integration circuit 432 is reset and the integration operation of the CCD 41 is interrupted. Subsequently, the CCD 41 outputs its stored charges, from which a judgment is made as to whether the exposure level of the CCD 41 has been appropriate. If the exposure level has been judged appropriate, the reference value I0 is used for determining later exposures. If the exposure level has been judged inappropriate, the reference value I0 is multiplied by k, for example, and I0×k is used for determining later exposures.

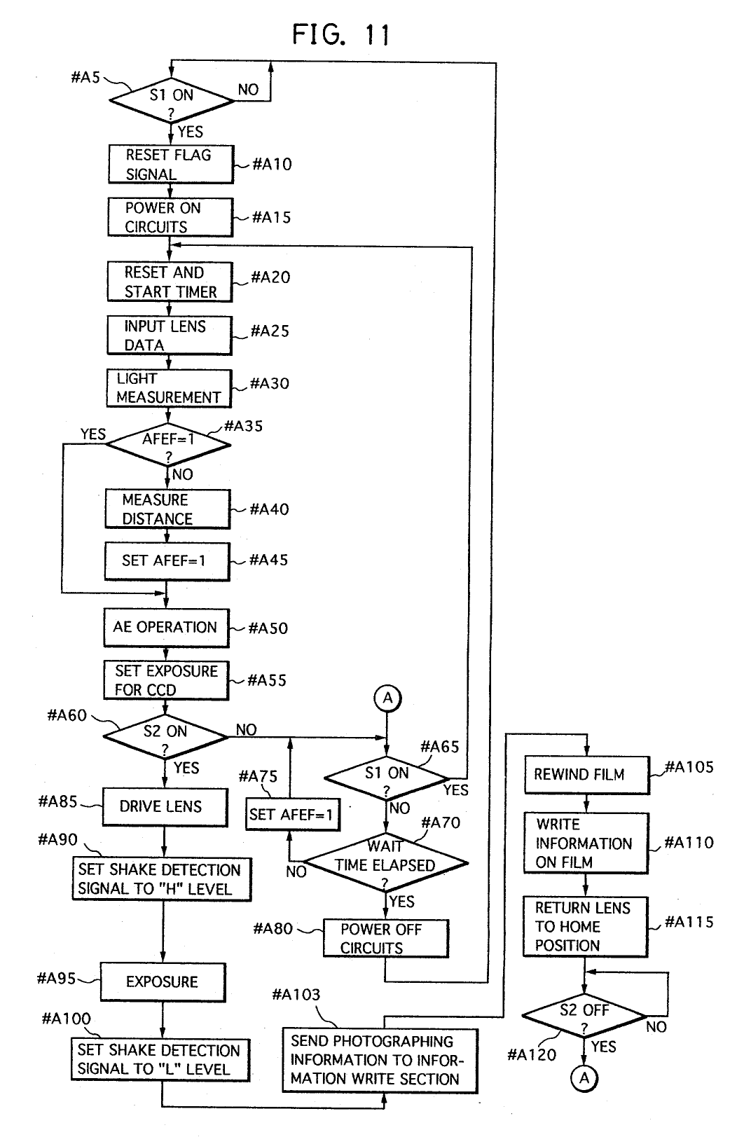

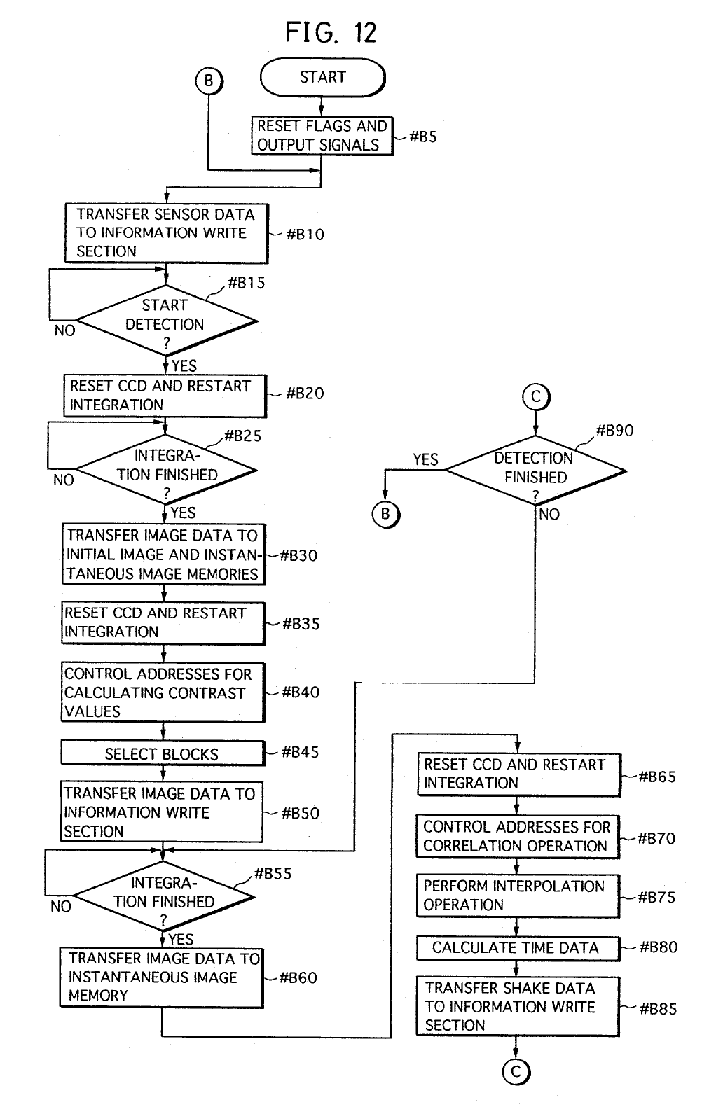

Referring now to flowcharts of FIGS. 11 and 12, operations of the main CPU 21 and camera shake detection control CPU 63 of the camera 1 will be described below.

First, the operation of the main CPU 21 is described referring to FIG. 11. The main CPU 21 is in a standby state in Step #A5, waiting for the switch S1 to turn on in a first stroke of the shutter release button 15. When the switch S1 is turned on, an automatic focusing complete flag AFEF and associated signals are reset in Step #A10 and power is supplied to the light measurement section 23, AF module 29, shake detector 32 and associated circuits in Step #A15.

Next, an internal timer of the main CPU 21 is reset and restarted in Step #A20, data about the lens 11 is inputted from the lens control circuit 25 in Step #A25 and light measurement is carried out in Step #A30.

In Step #A35, it is judged if the automatic focusing complete flag AFEF is in state “1”. If it is in state “1”, the operation flow skips to Step #A50. If it is not in state “1”, the operation flow proceeds to Step #A40. In Step #A40, the camera 1 measures the distance to the subject and in Step #A45, the automatic focusing complete flag AFEF is set to “1”. In Step #A50, the camera 1 performs a data processing operation for automatic exposure based on a light measurement value obtained in steps #A30, film speed and distance information obtained in Step #A40. Then, an exposure value for the CCD 41 is set in Step #A55.

In Step #A60, it is judged if the switch S2 has been turned on in a second stroke of the shutter release button 15. If the switch S2 is ON, the operation flow proceeds to Step #A85. If the switch S2 is not ON, the operation flow proceeds to Step #A65. In Step #A65, it is judged if the switch S1 is ON. If the switch S1 is ON, the operation flow returns to Step #A20. If the switch S1 is not ON in Step #A65, it is judged that the shutter release button 15 once depressed has been released. In this case, the operation flow proceeds to Step #A70, where judgment is made as to whether a specified time has elapsed using a clock signal produced by the internal timer of the main CPU 21. If it is judged that the specified time has elapsed, the light measurement section 23, AF module 29, shake detector 32 and associated circuits are powered off in Step #A80 and the operation flow returns to the standby state of Step #A5. If the specified time has not elapsed yet in Step #A70, the automatic focusing complete flag AFEF is set to state “1” in Step #A75 and the operation flow returns to Step #A65.

If it is judged that the switch S2 is ON in Step #A60, the lens 11 is driven to achieve correct focusing in Step #A85. Subsequently, a shake detection signal is set to an “H” level in Step #A90 and a camera shake detecting flow is started. In Step #A95, the shutter blade 26 is opened to begin an exposure. The exposure is finished when the shutter blade 26 is closed. Then, in Step #A100, the shake detection signal is set to an “L” level to annunciate the control CPU 63 that the exposure has finished. After each exposure, photographic information including the date and exposure value for that exposure is outputted to the information write section 33 (Step #A103).

When the film is rewound in Step #A105, the information write section 33 records shake information including amounts of shakes as well as the photographic information on the film in Step #A110. The lens 11 is returned to its home position in Step #A115. Then, after checking that the switch S2 has been turned off (Step #A120), the operation flow skips to Step #A65 to bring the camera back to a ready-to-operate condition.

Referring now to FIG. 12, the operation of the control CPU 63 is described. The shake detection operation starts when the shake detector 32 is powered on in Step #A15 of the flowchart of FIG. 11.

First, individual flags and output signals are reset in Step #B5. Next, data on the shake sensor 14 such as the number of pixels of the CCD 41 is outputted to the information write section 33 in Step #B10. In Step #B15, the control CPU 63 waits until the shake detection signal sent from the main CPU 21 changes to an “H” level.

When the signal becomes an “H” level, the control CPU 63 starts the camera shake detection flow. The control CPU 63 resets the CCD 41 and causes it to restart a new integration cycle in Step #B20. In Step #B25, the control CPU 63 waits until the integration cycle is finished. Upon completion of the integration cycle, red, green and blue components of pixel data are read out from the CCD 41 and transferred to respective storage areas in the initial image memory 52 and instantaneous image memory 53 (Step #B30). Then, the CCD 41 is reset again and restarts a second integration cycle (Step #B35).

In Step #B40, image contrast values are calculated for the red, green and blue components by processing the pixel data stored in the initial image memory 52 and instantaneous image memory 53. Then, the control CPU 63 selects blocks based on the resultant contrast values in Step #B45. At this point, the pixel data stored in the initial image memory 52 is outputted to the information write section 33 as initial image data (Step #B50).

In Step #B55, the control CPU 63 waits until the CCD 41 finishes the second integration cycle. Upon completion of the second integration cycle, red, green and blue components of new pixel data are transferred to the respective storage areas of the instantaneous image memory 53 (Step #B60). Then, the CCD 41 is reset once again and restarts a third integration cycle (Step #B65).

In Steps #B70 and #B75, the previously described correlation and interpolation operations are carried out for all of the red, green and blue components. In Step #B80, midpoint of each integration time period is calculated and in Step #B85, time data, horizontal shake data and vertical shake data are transferred to the information write section 33. Now, proceeding to Step #B90, the control CPU 63 judges if the shake detection signal fed from the main CPU 21 is at an “L” level. If the signal shows an “L” level, that means photographing has been completed and in this case the operation flow returns to Step #B10 and the camera shake detection flow is finished. On the contrary, if the signal is not “L” level, the operation flow skips to Step #B55 to continue the shake detection flow.

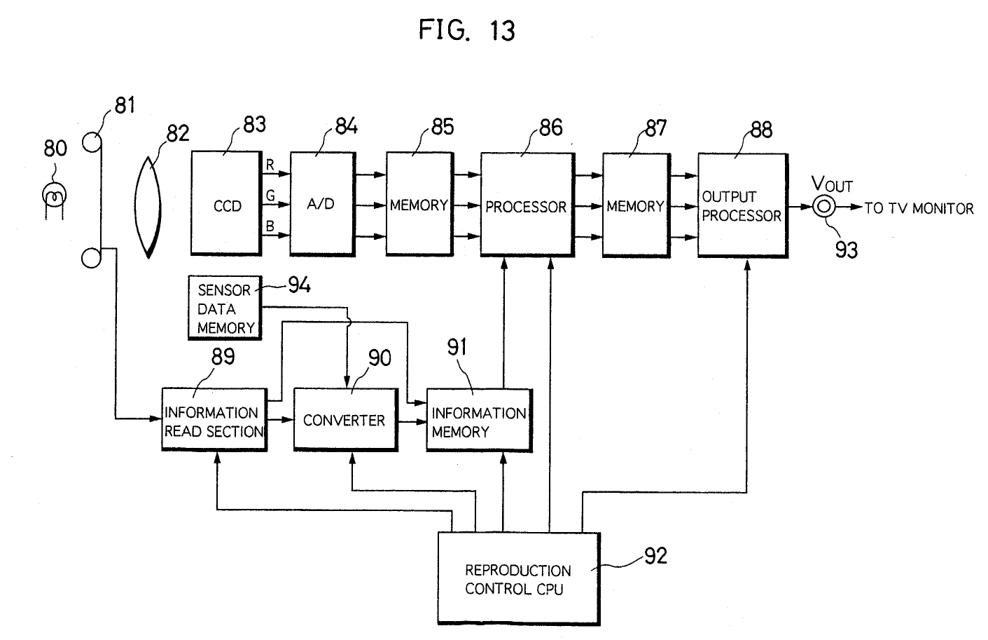

Described above are the operation flows of the main CPU 21 and control CPU 63 of the camera 1. Next, the image reproducing apparatus 3 of the image recording and reproducing system will be described. FIG. 13 is a block diagram showing an arrangement of principal components of the image reproducing apparatus 3. Indicated at reference number 81 is a developed film loaded in the film cartridge 2.

The image reproducing apparatus 3 converts an image recorded in each frame of the developed film 81 and reproduces that image on the TV monitor 4. Indicated at reference number 80 is a light source for illuminating the developed film 81. Indicated at reference number 82 is an optical system for forming an image in an illuminated frame of the developed film 81 on a photosensitive surface of an area image sensor 83 including a CCD. When an image on the developed film 81 is projected upon the image sensor 83, it converts the red, green and blue components of the image into respective electric signals (or image signals) and delivers these signals to a further stage. The image sensor 83 is associated with a sensor data memory 94 for storing such data as the number of pixels and pixel pitch of the image sensor 83 as well as the focal length of the optical system 82. The red, green and blue image signals outputted from the image sensor 83 are converted into digital signals by an A/D converter 84 and stored in a memory 85.

Indicated at reference number 89 is an information read section for reading such information as the shake information and photographic information including dates and exposure values which are recorded on the film. A converter 90 converts the shake information read by the information read section 89 into a format suited for the image reproducing apparatus 3. The shake information recorded on the film represents the amount of image shift observed on the CCD 41 of the shake sensor 14 of the camera 1.

This means that information of “a subject image having shifted X pixels rightward and Y pixels upward on the CCD 41 of the camera 1,” for example, cannot be directly utilized in the image reproducing apparatus 3 to compensate the image signals picked up by the image sensor 83. This is because the number of pixels and pixel pitch of the image sensor 83 of the image reproducing apparatus 3 are different from those of the CCD 41 of the camera 1. The initial image data recorded on the film also has a similar problem. The initial image data recorded by the camera 1 is originated from individual pixels of the CCD 41 of the shake sensor 14 and, therefore, it cannot be applied directly to the image sensor 83 of the image reproducing apparatus 3 on a pixel-to-pixel basis.

Accordingly, the converter 90 converts the shake information derived from the CCD 41 of the camera 1 into a format suited for the image sensor 83 of the image reproducing apparatus 3 based on such data as the number of pixels and pixel pitch of the shake sensor 14 and the data about the image sensor 83 of the image reproducing apparatus 3 read from the sensor data memory 94.

Specifically, p pixels on the CCD 41 correspond to p×P1×β1×β2/P2 pixels on the image sensor 83, where β1=(focal length f of lens 11)/(focal length fd of shake detecting optical system 13), β2 is the magnifying power of the optical system 82, P1 is the pixel pitch of the CCD 41, and P2 is the pixel pitch of the image sensor 83.

As seen above, the information read section 89 reads data recorded on the developed film 81. The shake information is converted by the converter 90 and then stored in an information memory 91. The photographic information read from the developed film 81 is directly stored in the information memory 91.

The converted shake information stored in the information memory 91 and the A/D-converted red, green and blue image signals stored in the memory 85 are both delivered to a processor 86. The processor 86 compensates the red, green, and blue image signals for camera shakes using an image processing technique. A detailed description of a shake compensating procedure will be given later. The processor 86 also performs image processing operations such as color balance adjustment based on the photographic information read out from the information memory 91. After shake compensation, color balancing and other adjustments and corrections whatsoever required, the red, green and blue image signals are outputted from the processor 86 and stored in a memory 87. Subsequently, the red, green and blue image signals are converted into NTSC format in an output processor 88 and delivered to the TV monitor 4 through an output terminal 93.

Indicated at reference number 92 is a reproduction control CPU 92 for executing overall control of the image reproducing apparatus 3, including shake compensating operation.

The shake compensating procedure performed by the processor 86 using an image processing technique will be described below. The processor 86 estimates and reproduces an original image by processing a blurred image on the developed film 81 based on the shake information recorded on the developed film 81. Although the processor 86 performs shake compensation of the red, green and blue components of the image, the following description deals with compensation of the red component only. This is because the same procedure can be used for compensation of the three primary color components. Accordingly, pixel data, shake information and deterioration functions referred to in the following description are those of the red component.

By expressing pixel data of the blurred image by g(x, y) and pixel data of the original image by f(x, y), a relationship between the two images is given by the following equation:

g(x, y)=∫∫hxy(x-x′, y-y′) f(x′, y′) dx′dy′ (9)

For digital image processing, the above equation can be rewritten as follows:

$$g ( i , j ) = {\sum }_{k} {\sum }_{l} h i j ( i - k , j - l ) f ( k , l ) \qquad ( 10 )$$

where

$${\sum }_{k} {\sum }_{l} hij ( k , 1 ) = 1 ,$$

and hxy(x-x′, y-y′) and hij(i-k, j-l) are deterioration functions representing image deterioration caused by camera shake.

Referring to Equation (10), g(i, j) is pixel data of at coordinates (i, j) of the image sensor 83 and f(k, l) is original pixel data to be restored at coordinates (k, l) of the image sensor 83, where i≠k and l≠j.

Equation (9) indicates that pixel data g(x, y) at coordinates (x, y) of a blurred image is derived from original image pixel data f(x, y) at coordinates (x, y) but affected by pixel data f(x′, y′) at coordinates (x′, y′) which are different from coordinates (x, y). The deterioration function hxy indicates to which extent original image pixel data f(x, y) was affected or deteriorated by pixel data f(x′, y′) at different coordinates. Similarly, Equation (10) indicates that pixel data g(i, j) at coordinates (i, j) of a blurred image is derived from original image pixel data f(i, j) at coordinates (i, j) but affected by pixel data f(k, l) at coordinates (k, l) which are different from coordinates (i, j). The deterioration function hij indicates to which extent original image pixel data f(i, j) was affected or deteriorated by pixel data f(k, l) at different coordinates.

Provided that the image sensor 83 has mxn pixels, i=k=1 to m, j=l=1 to n, and the deterioration function hij(i−k, j−l) makes a matrix of m rows by n columns.

The processor 86 performs image processing using digital pixel data for all of the red, green and blue components fed from A/D converter 84 via the memory 85. Accordingly, the following description can be made based on Equation (10).

The processor 86 receives shake data including time data (ts), horizontal shake data (Xs) and vertical shake data (Ys) from the information memory 91, where s=0, 1, . . . , p. The horizontal and vertical shake data (Xs, Ys) represent values of the horizontal and vertical shake data at time ts, respectively. The deterioration function hij is obtained by using shake data (ts, Xs, Ys). Assuming that the initial value of hij is 0, the deterioration function hij is given by the following equation:

hij(Xs, Ys)=hij(Xs, Ys)+(ts+1−ts−1)/2tp (11)

where s=0, 1, . . . p−1, t−1=0, tp+1=tp.

Pixel data gij(i, j) of the blurred image is known since the illuminated image on the developed film 81 is converted into electric signals by the image sensor 83 and these signals are inputted to the processor 86. Also, the deterioration function hij is obtainable from Equation (11). Substituting gij(Xt, Yt) and hij into Equation (10), mxn simultaneous equations can be obtained.

It should, however, be recognized that pixel data gij(i, j) of the blurred image is generated from pixel data f(i, j) of the original image as it is affected by surrounding pixel data f(k, l). Therefore, the number of pixel data composing the original image is larger than the number of pixel data composing the blurred image. In other words, the original image has a larger size than the blurred image. As a result, the mxn simultaneous equations obtained from Equation (10) contain unknown pixel data contributed form the outside regions of the blurred image. This means that the simultaneous equations contain more than mxn unknowns and, therefore, it is impossible to solve the simultaneous equations as they are. To overcome this problem, dummy data or a predetermined value is substituted for each of the unknown pixel data. By doing so, the number of unknowns is reduced to mxn so that the simultaneous equations can be solved.

Dummy data to substitute for the unknown pixel data may be uniformly set to a fixed value. In this case, the fixed value could readily be stored in the information memory 91. Alternatively, dummy data may be approximated by pixel data g(i, j) of outermost pixels of the blurred image or by an average of pixel data taken from the pixel data of the blurred image. In this case, dummy data could be calculated by the processor 86 from the inputted pixel data gij(i, j).

An exemplary case of original image restoration by the aforementioned shake compensating procedure will be described. To simplify the description, it is assumed that image deterioration due to camera shake occurs uniformly over the entire pixels of the image sensor 83.

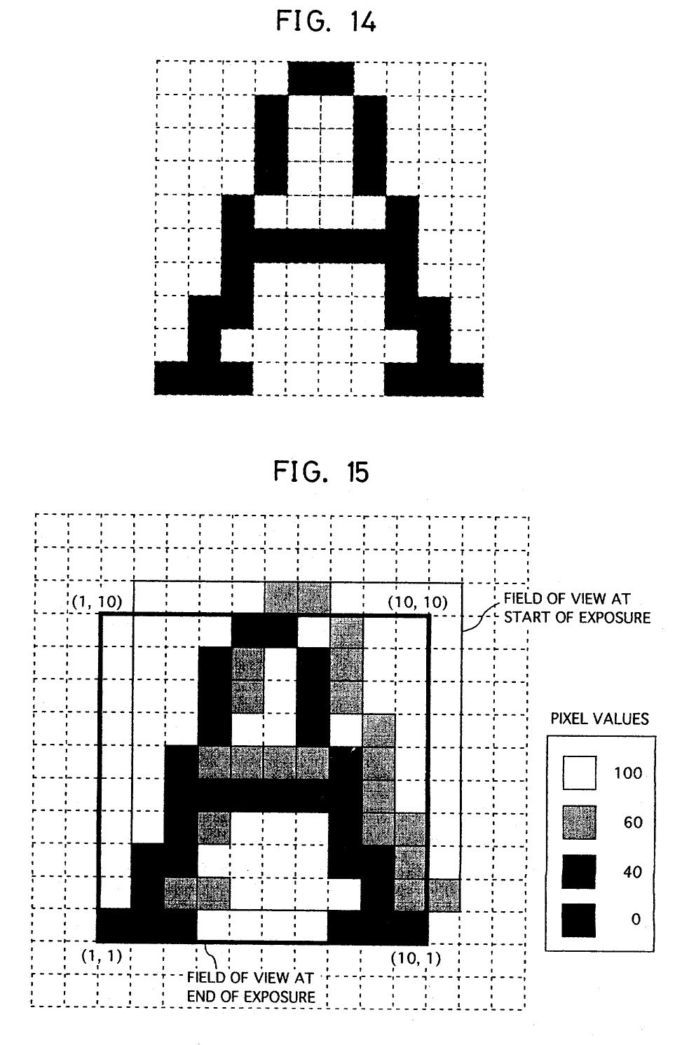

FIG. 14 is a diagram exemplarily showing an original image. For the sake of simplicity, the number of pixels of the image sensor 83 is reduced to 10×10 here.

FIG. 15 is a diagram showing a blurred image caused by shaking. In the example of FIG. 15, it would be noticed that the field of view of the camera 1 moved one pixel leftward and one pixel downward (as related to the pixel size of the image sensor 83) between the start time and end time of an exposure. Alternatively, it may be understood that the subject image shifted one pixel rightward and one pixel upward during an exposure. In this case, pixel data g(i, j) of the blurred image obtained in the image reproducing apparatus 3 would be as shown by the shaded pixels enclosed by a thick square A2 which corresponds to the field of view of the camera 1 at the end of exposure. In this embodiment, the lower-left pixel contained in the field of view at the end of exposure is designated by coordinates (1, 1) with horizontal and vertical axes extending rightward and upward, respectively, from the lower-left corner of the thick square as shown in FIG. 15.

It is now assumed that shake detection was performed five times during an exposure and the following set of shake data (ts, Xs, Ys) was obtained:

(0.0, 0, 0)

(0.1, 0, 0)

(0.2, 0, 0) (12)

(0.3, 1, 1)

(0.4, 1, 1)

(0.5, 0, 0)

The above shake data indicates that point (i, j) was exposed to the original or unshaken image at points of time t=0.0, 0.1, 0.2 and 0.5, and to a shaken image at points of time t=0.3 and 0.4. Substituting the above shake data into Equation (11),

t=t0=0.0:

hij(0, 0)=hij(0, 0)+(0.1−0.0)/(2×0.5)=0.1

t=t1=0.1:

hij(0, 0)=hij(0, 0)+(0.2−0.0)/(2×0.5)=0.3

t=t2=0.2:

hij(0, 0)=hij(0, 0)+(0.3−0.1)/(2×0.5)=0.5 (13)

t=t3=0.3:

hij(1, 1)=hij(1, 1)+(0.4−0.2)/(2×0.5)=0.2

t=t4=0.4:

hij(1, 1)=hij(1, 1)+(0.5−0.3)/(2×0.5)=0.4

t=t5=0.5:

hij(0, 0)=hij(0, 0)+(0.5−0.4)/(2×0.5)=0.6

Thus,

hij(0, 0)=0.6

hij(1, 1)=0.4

The deterioration function hij is therefore written as follows:

$$\begin{matrix}\begin{matrix} … - 2 & - 1 & 0 & 1 & 2 & …\end{matrix} & ( 14 ) \\ hij = \begin{matrix}∷ \\ 2 \\ 1 \\ 0 \\ - 1 \\ - 2 \\ ∷\end{matrix} [ \begin{matrix} \\ \\ \\ … \\ \\ \\ \end{matrix} \begin{matrix} & & ∷ & & & \\ 0 & 0 & 0 & 0 & 0 & \\ 0 & 0 & 0 & 0.4 & 0 & \\ 0 & 0 & 0.6 & 0 & 0 & … \\ 0 & 0 & 0 & 0 & 0 & \\ 0 & 0 & 0 & 0 & 0 & \\ & & ∷ & & & \end{matrix} ] & \end{matrix}$$

Substituting the deterioration function hij obtained above into Equation (10),

$$\begin{matrix}g ( i , j ) = hji ( 0 , 0 ) f ( i , j ) + hji ( 1 , 1 ) f ( i - 1 , j - 1 ) \\ = 0.6 f ( i , j ) + 0.4 f ( i - 1 , j - 1 )\end{matrix} \qquad ( 15 )$$

Substituting pixel data gij(i, j) of the blurred image actually obtained by the image sensor 83 into Equation (15), 10×10 simultaneous equations are obtained as shown below:

$$\begin{matrix}g ( 1 , 1 ) = 40 = 0.6 f ( 1 , 1 ) + 0.4 f ( 0 , 0 ) & ( 16 ) \\ g ( 2 , 1 ) = 40 = 0.6 f ( 2 , 1 ) + 0.4 f ( 1 , 0 ) & \\ ⋮ & \\ g ( i , j ) = 40 = 0.6 f ( i , j ) + 0.4 f ( i - 1 , j - 1 ) & \\ ⋮ & \\ g ( 10 , 9 ) = 40 = 0.6 f ( 10 , 9 ) + 0.4 f ( 9 , 8 ) & \\ g ( 10 , 10 ) = 40 = 0.6 f ( 10 , 10 ) + 0.4 f ( 9 , 9 ) & \end{matrix}$$

The above simultaneous equations contain 119 (=10×10+(10+10−1)) unknowns, of which 19 (=10+10−1) unknowns are pixel data f(i,0) and f(0, j), where i=0 to 9 and j=1 to 9, corresponding to 19 pieces of pixel data located along the lower and left borders of the image pickup area A1 at the start of exposure shown in FIG. 15. Since the above simultaneous equations cannot be solved as they are, unknown pixel data f(i, 0) and f(0, j) are replaced by dummy data or a predetermined value 100, for example. Then, simultaneous Equations (16) can be rewritten as

$$\begin{matrix}g ( 1 , 1 ) = 40 = 0.6 f ( 1 , 1 ) + 0.4 \times 100 & ( 17 ) \\ g ( 2 , 1 ) = 40 = 0.6 f ( 2 , 1 ) + 0.4 \times 100 & \\ ⋮ & \\ ⋮ & \\ g ( 10 , 10 ) = 40 = 0.6 f ( 10 , 10 ) + 0.4 f ( 9 , 9 ) & \end{matrix}$$

Now that the above simultaneous equations contain 10×10 unknowns, it is possible to obtain pixel data f(i, j) of the original image by solving the simultaneous equations.

So far described is the procedure for obtaining pixel data f(i, j) of the original image from pixel data g(i, j) of the blurred image using shake data (ts, Xs, Ys). Although the above description has dealt with compensation of the red component of the pixel data, the same procedure can be used for compensation of the green and blue components as well.

In this calculation, it is assumed that unknown pixel data of each pixel outside the blurred image area shown by the thick square in FIG. 15 is 100. It would however be recognized that, in order to reproduce a correct original image, it is preferable to approximate pixel data of those pixels located outside the blurred image area based on the pixel data of the blurred image which contains information on the photographed subject rather than substituting a predetermined value for all unknown pixel data. Described below is a second calculation in which unknown pixel data of individual outside pixels are approximated using pixel data of the blurred image.

In the second calculation, unknown pixel data of each pixel outside the blurred image area is replaced by pixel data g(i, j) of an adjacent pixel which is located inside the boundary of the blurred image. Specifically, the following pixel data of the blurred image are substituted for unknown pixel data f(0 to 9, 0) and f(0, 1 to 9) in simultaneous Equations (16):

$$\begin{matrix}f ( 0 , 0 ) = g ( 1 , 1 ) = 40 \\ ⋮ \\ f ( i , 0 ) = g ( i , 1 ) \\ ⋮ \\ f ( 9 , 0 ) = f ( 9 , 1 ) = 40 \\ ⋮ \\ f ( 0 , 1 ) = g ( 1 , 1 ) = 40 \\ ⋮ \\ f ( 0 , j ) = g ( 1 , j ) = 40 \\ ⋮ \\ f ( 0 , 9 ) = g ( 1 , 9 ) = 100 \\ \end{matrix} \qquad ( 18 )$$

The number of unknowns is reduced to 10×10 by the above substitution and it is now possible to solve simultaneous Equations (16) in the same manner as the earlier calculation. In this calculation, the unknown pixel data are approximated by the known pixel data of the blurred image which contains information about the photographed subject. This approach makes it possible to reproduce the original image more exactly compared to the earlier calculation in which a predetermined value is automatically substituted for all unknown pixel data. Furthermore, since a photographed image of a typical subject often causes adjacent pixels to have pixel data close to each other, this alternative approach is efficient for accurate reproduction of the original image.

Further, it is possible to use an average of pixel data derived from the pixel data of the blurred image for substitution.

Described below is a third calculation which can reproduce the original image even more exactly. In this calculation, initial image data recorded by the camera 1 is substituted for unknown pixel data. The initial image data is recorded on a film in accordance with the procedure already described.

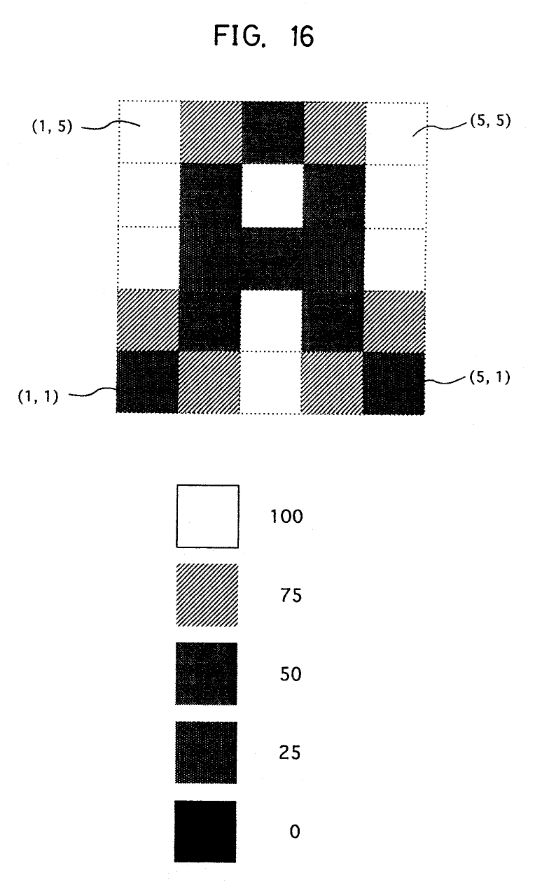

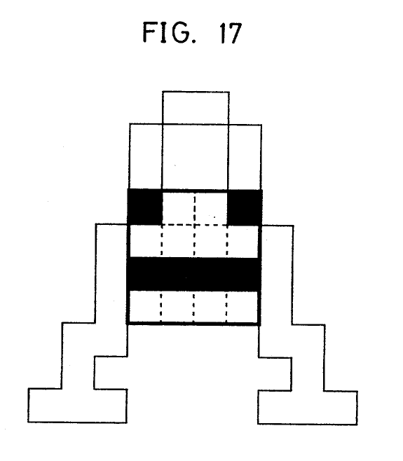

FIG. 16 is a diagram showing a blurred image picked up by the shake sensor 14 of the camera 1 from a subject of which original image is shown in FIG. 14. The shake sensor 14 of the camera 1 typically has a smaller number of pixels and provides lower resolution compared to the image sensor 83 of the image reproducing apparatus 3. For simplicity, it is assumed here that the shake sensor 14 has 5×5 pixels. Further, the lower-left pixel of the shake sensor 14 is designated by coordinates (1, 1) with horizontal and vertical axes extending rightward and upward, respectively, from the lower-left corner as shown in FIG. 16, and pixel data of each pixel is expressed by e(k, l) (where k=1 to 5, and l=1 to 5). The camera 1 records pixel data e(k, l) as the initial image data on a film.

The information read section 89 of the image reproducing apparatus 3 reads pixel data e(k, l) of the initial image recorded on the film. Then, the converter 90 converts pixel data e(k, l) of the initial image into a format suited for processing in the image reproducing apparatus 3. As an example, the converter 90 carries out the following operation to provide reformatted pixel data e′(i, j) (where i=1 to 10, and j=1 to 10) of the initial image:

$$\begin{matrix}{e}^{′} ( 1 , 1 ) = {e}^{′} ( 2 , 1 ) = {e}^{′} ( 1 , 2 ) \\ = {e}^{′} ( 2 , 2 ) = {e}^{} ( 1 , 1 ) = 25 \\ {e}^{′} ( 3 , 1 ) = {e}^{′} ( 4 , 1 ) = {e}^{′} ( 3 , 2 ) \\ = {e}^{′} ( 4 , 2 ) = {e}^{} ( 2 , 1 ) = 75 \\ ⋮ ⋮ \\ {e}^{′} ( 2 k - 1 , 11 - 1 ) = {e}^{′} ( 2 k , 21 - 1 ) \\ = {e}^{′} ( 2 k - 1 , 21 ) = {e}^{′} ( 2 k , 21 ) = e ( k , 1 ) \\ ⋮ ⋮ \\ {e}^{′} ( 9 , 9 ) = {e}^{′} ( 10 , 9 ) \\ = {e}^{′} ( 9 , 10 ) = {e}^{′} ( 10 , 10 ) = e ( 5 , 5 ) = 100\end{matrix} \qquad ( 19 )$$

A series of converted pixel data e′(i, j) of the initial image outputted from the converter 90 are stored in the information memory 91.

Pixel data e′(i, j) of the initial image is then substituted for the unknown pixel data. Specifically, individual values of the following pixel data e′(i, j) are substituted for unknown pixel data f(0 to 9, 0) and f(0, 1 to 9) of simultaneous Equations (16):

$$\begin{matrix}f ( 0 , 0 ) = {e}^{′} ( 1 , 1 ) = 25 \\ ∷ \\ f ( i , 0 ) = {e}^{′} ( i , 1 ) \\ ∷ \\ f ( 9 , 0 ) = {e}^{′} ( 9 , 1 ) = 25 \\ f ( 0 , 1 ) = {e}^{′} ( 1 , 1 ) = 25 \\ ∷ \\ f ( 0 , j ) = {e}^{′} ( 1 , j ) \\ ∷ \\ f ( 0 , 9 ) = {e}^{′} ( 1 , 9 ) = 100\end{matrix} \qquad ( 20 )$$

The number of unknowns is reduced to 10×10 by the above substitution and it is now possible to solve simultaneous Equations (16) in the same manner as the first and second calculations.

In this calculation, the initial image data recorded by the camera 1 is used to substitute for the unknown pixel data. Since the initial image data is essentially pixel data recorded immediately after the start of exposure, it is very close to pixel data f(i, j) the original image. This approach makes it possible to reproduce the original image more exactly compared to the first calculation in which a predetermined value is automatically substituted for all unknown pixel data, or the second calculation in which pixel data derived from pixel data g(i, j) of the blurred image are substituted for the unknown pixel data.

According to the third calculation, the camera 1 records pixel data of all pixels of the shake sensor 14 on the film as the initial image data. It should however be recognized from the above description that pixel data obtained from the central portion of the shake sensor 14 is not actually used for substitution. This is because the unknown pixel data are contributions from fractional parts of the subject around the boundary of the photographed area. Accordingly, it may be appreciated that the camera 1 is made to record pixel data obtained from only the boundary elements of the shake sensor 14. This will help reduce the amount of data to be recorded on the film saving the data recording area thereof.

It should further be recognized from the above description that if the subject image has shifted one pixel rightward and one pixel upward during an exposure, unknown pixel data will be taken from the leftmost column and the lower-most row of pixels. Similarly, if the subject image has shifted just one pixel leftward during an exposure, unknown pixel data will be taken from only the rightmost column of pixels. Also, if the subject image has shifted two pixels downward during an exposure, unknown pixel data will be taken from the upper two rows of pixels.

Further, it may be appreciated that the camera 1 is made to first determine which portions of the pixel data would actually be required to substitute for unknown pixel data based on the detected shake data, and then record only such portions of the pixel data on the film as the initial image data. This will bring a further reduction in the amount of data to be recorded on the film.

A fourth calculation will now be described. In the fourth calculation, the shake sensor 14 of the camera 1 picks up an image from only a central portion of the photographed area and resultant pixel data is recorded on the film as the initial image data.

FIG. 17 is a diagram showing an image picked up by the shake sensor 14 from only a central portion of a photographed subject of which original image is as shown in FIG. 14. For simplicity, it is assumed here that the shake sensor 14 has 4×4 pixels. The fourth calculation provides higher resolution and more precise initial image data than the third calculation of which shake sensor 14 picks up the whole image within the photographed area. The camera 1 of the fourth calculation records pixel data as shown in FIG. 17 on the film as the initial image data.

In the fourth calculation, the reading is executed of the initial image data recorded on the film. The converter 90 converts the initial image data and the resultant data is stored in the information memory 91. When the processor 86 carries out shake compensating operations, the converted initial image data is substituted in simultaneous Equations (16). Specifically, pixel data of the initial image is substituted for pixel data f(i, j) (where i=4 to 7, j=4 to 7) of the original image.

The fourth calculation does not provide a complete solution of simultaneous Equations (16). Pixel data of the original image cannot be obtained for some fractional regions, especially for boundary regions, of the photographed area because nothing is substituted for the unknown pixel data of the equations. Nevertheless, this calculation enables accurate reproduction of the original image in the central portion, i.e., f(4 to 7, 4 to 7), of the photographed area by substitution of the initial image data. It is typical practice in photography to locate a main subject in the middle of the field of view. It is therefore quite effective to reproduce the central part of the original image with high accuracy. With respect to the boundary regions of the photographed area where pixel data of the original image cannot be obtained from simultaneous Equations (16), the first or second calculation could be used to reproduce the original image.

So far described is how the processor 86 compensates for camera shakes by using an image processing technique.

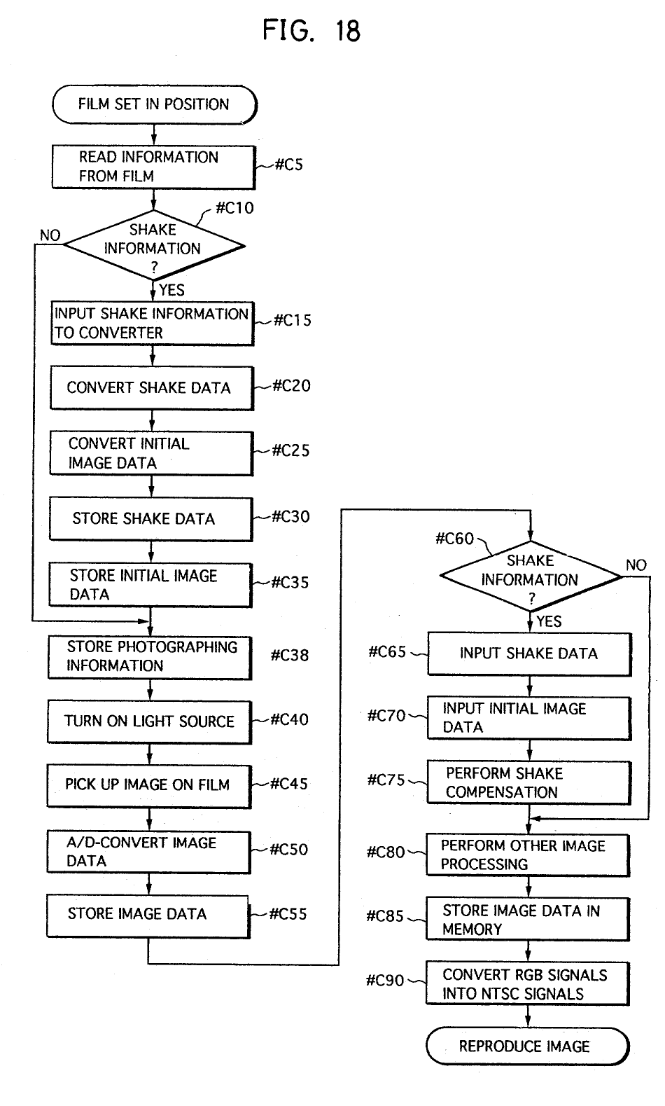

Referring now to the flowchart of FIG. 18, a reproducing operation of the image reproducing apparatus 3, including the aforementioned shake compensation procedure, will be described. It is assumed that the film cartridge 2 is already mounted in the image reproducing apparatus 3. The flow shown in FIG. 18 starts when a frame carrying an image to be reproduced has been set in position and is finished when a reproduced image is displayed on the TV monitor 4.

In Step #C5, the information read section 89 reads the information recorded on the developed film 81. Then, in Step #C10, the read information is checked to determine if it contains shake information. If there is no shake information, the operation flow skips to Step #C38 where the information memory 91 stores the photographic information read from the developed film 81 in Step #5. If shake information is found in Step #C10, data on the shake sensor 14 is inputted to the converter 90 in Step #C15. In Steps #C20 and #C25, the converter 90 converts the shake data and initial image data read from the developed film 81 into a format suited for shake compensation processing by the processor 86 based on the shake sensor data including the number of pixels and image pickup area of the shake sensor 14. The converted shake data and initial image data are stored in the information memory 91 in Steps #C30 and #C35, respectively. The photographic information is then stored in the information memory 91 in Step #C38.

The image reproducing apparatus 3 now proceeds to an image reproduction process starting at Step #C40. First, the light source 80 is turned on in Step #C40 to illuminate the frame of image set in position. The image sensor 83 picks up the image and converts it into red, green and blue components of pixel data in Step #C45. The red, green and blue pixel data components are individually A/D-converted by the A/D converter 84 in Step #C50 and stored in the memory 85 in Step #C55.

In Step #C60, it is judged whether the shake information is available. If no shake information is recorded on the developed film 81, the operation flow skips to Step #C80. If the shake information is available, the processor 86 reads the shake data and initial image data from the information memory 91 in steps #C65 and #C70, respectively. In Step #C75, the processor 86 performs shake compensation on the pixel data using the shake data and initial image data. The shake compensating procedures have already been described above. Upon compensating the red, green and blue components of the pixel data for shakes, the processor 86 performs such as color balance adjustment in Step #C80.

After shake compensation and other image processing operations, the pixel data is stored in the memory 87 in Step #C85 and delivered to the output processor 88. In Step #C90, the output processor 88 converts the red, green and blue image signals into NTSC format and the resultant NTSC video signals are outputted to the TV monitor 4 through the output terminal 93. Eventually, the TV monitor 4 displays an image reproduced from what is recorded on the first frame of the developed film 81.

After reproducing one frame of image, the image reproducing apparatus 3 feeds the developed film 81 and sets a next frame in position. Then, the image reproducing apparatus 3 repeats the foregoing routine, starting from Step #C5, to reproduce the image recorded on the newly set frame.

Although the shake information obtained by the camera 1 is recorded on a film in this embodiment, it may be appreciated to use an information storage medium. For example, it may appreciated to record shake information on an IC card which is to be read by an image reproducing apparatus.

Furthermore, in the above-described embodiment, a silver salt camera is used as the image recording apparatus. However, according to the present invention, it may be possible to use a movie video camera or a still video camera. In this case, the video camera may record detected shake information on a specified area (e.g., an audio track) of a video tape or a floppy disk. Then, a video tape player or a still video player, working as an image reproducing apparatus, could read the recorded shake information and carry out shake compensation in accordance with the aforementioned calculation.

Moreover, in the above embodiment, a reproduced image is displayed on a TV monitor screen. However, it may be appreciated to sent compensated image signals to a printer which in turn reproduces a photographed image on copy paper.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. An image recording and reproducing system comprising a recording device and a reproducing device;
the recording device including:
first recording means for recording an image of a subject on a recording medium;
detecting means or detecting information about deterioration of the subject image recorded on the recording medium by the first recording means; and
second recording means for recording the detected deterioration information; and
the reproducing device including:
image reproducing means for reproducing the subject image recorded on the recording medium;
calculating means for calculating a function indicative of a deterioration characteristic of the recorded subject image based on the recorded deterioration information; and
correcting means for correcting the recorded subject image in accordance with the calculated deterioration characteristic.

2. An image recording and reproducing system according to claim 1 wherein the deterioration information has information about a shake of the recorded subject image.

3. An image recording and reproducing system according to claim 1 wherein the second recording means records the detected deterioration information on the same recording medium as the subject image.

4. An image recording and reproducing system according to claim 1 wherein the first recording means includes means for recording an image of a subject on a recording medium in an optical way, and the image reproducing means includes means for converting the recorded subject image to a video signal.

5. An image recording and reproducing system according to claim 4 wherein the correcting means includes means for processing the video signal to correct the recorded subject image.

6. An image recording and reproducing system comprising:
image recording means for recording an image of a subject on a recording medium;
detecting means for detecting information about deterioration of the subject image recorded on the recording medium;
image reproducing means for reproducing the subject image recorded on the recording medium;
outputting means for outputting a predetermined image information; and
correcting means for correcting the recorded subject image based on the detected deterioration information and the output image information.

7.An image recording and reproducing system according to claim 6 wherein the deterioration information has information about a shake of the recorded subject image.

8. An image recording and reproducing system according to claim 6 wherein the image information has a specified constant value.

9. An image recording and reproducing system according to claim 6 wherein the image information is determined based on the subject image.

10. An image recording and reproducing system according to claim 6 wherein the image recording means includes means for recording an image of a subject on a recording medium in an optical way, and the image reproducing means includes means for converting the recorded subject image to a video signal.

11. An image recording and reproducing system according to claim 10 wherein the correcting means includes means for processing the video signal to correct the recorded subject image.

12. An image recording and reproducing system comprising a recording device and a reproducing device;
the recording device including:
first recording means for recording an image of a subject on a recording medium;
detecting means or detecting information about deterioration of the subject image recorded on the recording medium;
second recording means for recording the detected deterioration information; and
third recording means for recording information about an initial subject image immediately after starting the image recording; and
the reproducing device including:
image reproducing means for reproducing the subject image recorded on the recording medium by the first recording means; and
correcting means for correcting the recorded image based on the recorded deterioration information and the recorded initial subject image information.

13. An image recording and reproducing system according to claim 12 wherein the deterioration information has information about a shake of the recorded subject image.

14. An image recording and reproducing system according to claim 12 wherein the second and third recording means record the detected deterioration information and the earlier subject image information on the same recording medium as the subject image.

15. An image recording and reproducing system according to claim 12 wherein the first recording means includes means for recording an image of a subject on a recording medium in an optical way, and the image reproducing means includes means for converting the recorded subject image to a video signal.

16. An image recording and reproducing system according to claim 15 wherein the correcting means includes means for processing the videos signal to correct the recorded subject image.

17. An image reproducing apparatus comprising:
image reproducing means for reproducing an image recorded on a developed film;
detecting means for detecting information about deterioration of the image recorded on the developed film;
calculating means for calculating a function indicative of a deterioration characteristic of the recorded image based on the detected deterioration information; and
correcting means for correcting the recorded image in accordance with the calculated deterioration characteristic.

18. An image reproducing apparatus according to claim 17 wherein the deterioration information has information about a shake of the recorded image.

19. An image reproducing apparatus according to claim 17 wherein the image reproducing means includes means for converting the recorded image to a video signal.

20. An image recording and reproducing system according to claim 19 wherein the correcting means includes means for processing the video signal to correct the recorded image.

21. An image reproducing apparatus comprising:
image reproducing means for reproducing an image recorded on a developed film;
detecting means for detecting information about deterioration about the image recorded on the developed film;
outputting means for outputting a predetermined image information; and
correcting means for correcting the recorded image based on the detected deterioration information and the output image information.

22. An image reproducing system according to claim 21 wherein the deterioration information has information about a shake of the recorded image.

23. An image reproducing system according to claim 21 wherein the image information has a specified constant value.

24. An image reproducing system according to claim 21 wherein the image information is determined based on the recorded image.

25. An image reproducing system according to claim 21 wherein the image reproducing means includes means for converting the recorded image to a video signal.

26. An image reproducing system according to claim 25 wherein the correcting means includes means for processing the video signal to correct the recorded image.
